(19) United States
(12) Patent Application Publication
(10) Pub. No.: US 2017/0274545 A1
(43) Pub. Date: Sep. 28, 2017

(54) ADJUSTABLE STRIP CUTTING RULER

(71) Applicant: Gary DARWIN, Sunburst, MT (US)

(72) Inventor: Gary DARWIN, Sunburst, MT (US)

(21) Appl. No.: 15/469,924

(22) Filed: Mar. 27, 2017

Related U.S. Application Data
(60) Provisional application No. 62/313,347, filed on Mar. 25, 2016.

(51) Int. Cl. B26B 29/06; D06H 7/00; G01B 3/04

(52) U.S. Cl. CPC B26B 29/06; G01B 3/04; D06H 7/00

(57) ABSTRACT

An adjustable strip cutting ruler may be provided. The adjustable strip cutting ruler may include a ruler body with at least one track for slidably mounting a glide. The ruler body may include measurement markings to align the glide at a desired width for cutting strips. The adjustable strip cutting ruler may further include fasteners for mounting the glide to the tracks of the ruler body.

### PRIORITY

This application claims priority to U.S. Provisional Application No. 62/313,347, filed Mar. 25, 2016, the contents of which are herein incorporated by reference.

### BACKGROUND

Sheet-like materials such as fabric and other textiles are produced in a variety of sizes, lengths, textures, and compositions of matter. These materials are typically sold in lengthy segments with the intention of being further modified into custom lengths, sizes, angles, and shapes. Sheet-like material may be cut with rotary tools, razors, scissors, and other similarly situated devices. It may be difficult to cut these materials into precise lengths, sizes, angles, and shapes. Additionally, it may be difficult to cut multiple pieces of fabric simultaneously and safely.

### SUMMARY

According to an exemplary embodiment, an adjustable strip cutting ruler may be provided, The adjustable strip cutting ruler may have a ruler body with a top surface and a bottom surface. The ruler body may further include at least one track extending therethrough along a lateral axis. A glide may be coupled to the bottom surface of the ruler body and configured to slide along a length of the at least one track. The glide may be mounted to the at least one track via at least one fastener pivotally attached thereto. The ruler body may also have at least one set of ruler markings spaced along the lateral axis thereof.

According to another exemplary embodiment, a method of cutting a strip of material may be provided. The method may include providing a strip of material to be cut. An adjustable strip cutting ruler may also be provided. The adjustable strip cutting ruler may include a ruler body having a top surface and a bottom surface, at least one track extending through the ruler body along a lateral axis thereof, a glide coupled to the bottom surface of the ruler body and configured to slide along a length of the at least one track, at least one fastener pivotally attached to the glide for mounting the glide to the at least one track, and at least one set of ruler markings spaced along the lateral axis of the ruler body. The glide may be secured at a desired position along the length of the at least one track. The desired position may correspond to a desired width for the strip of material to be cut. The adjustable strip cutting ruler may be positioned atop the at least one sheet of material with an edge of the glide abutting an edge of the at least one sheet of material. The at least one sheet of material may be cut along a longitudinal side of the ruler body.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

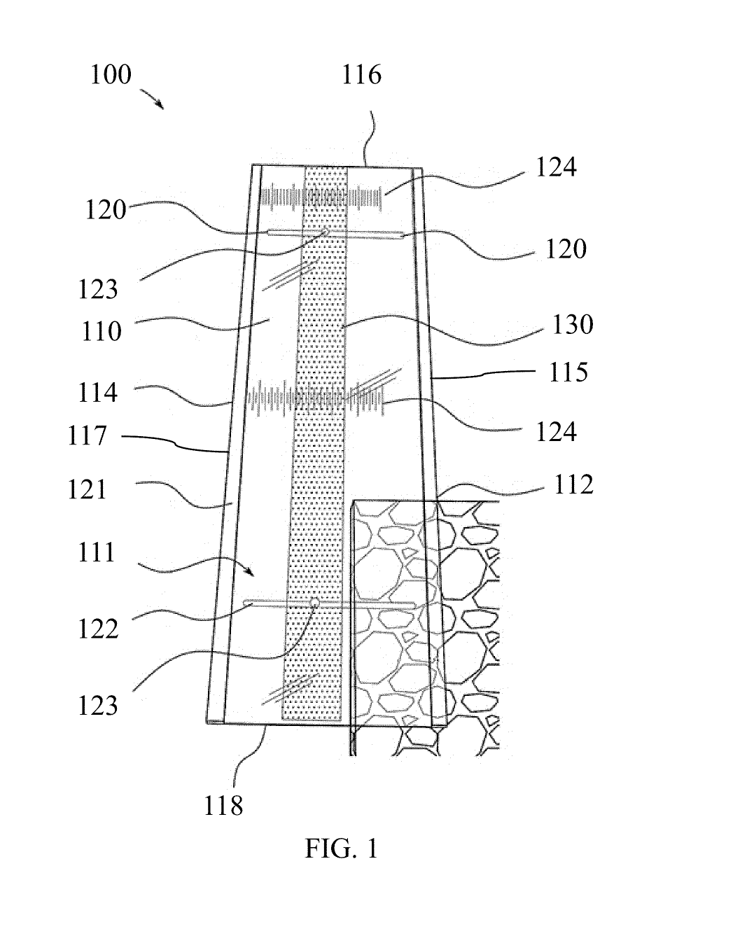

Exemplary FIG. 1 may show an adjustable strip cutting ruler;

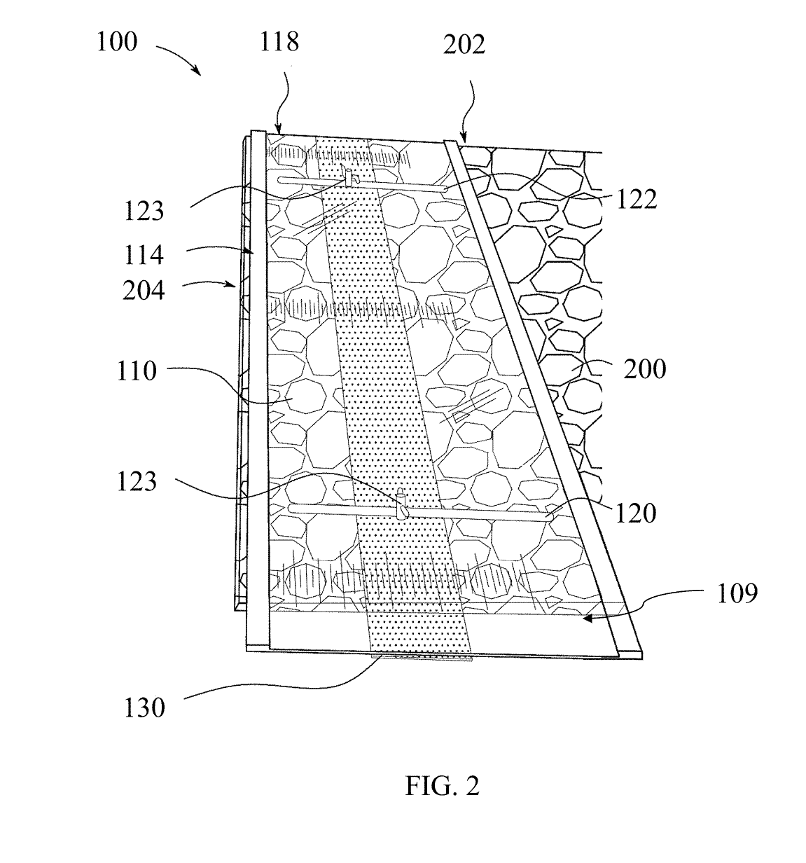

Exemplary FIG. 2 may show an adjustable strip cutting ruler;

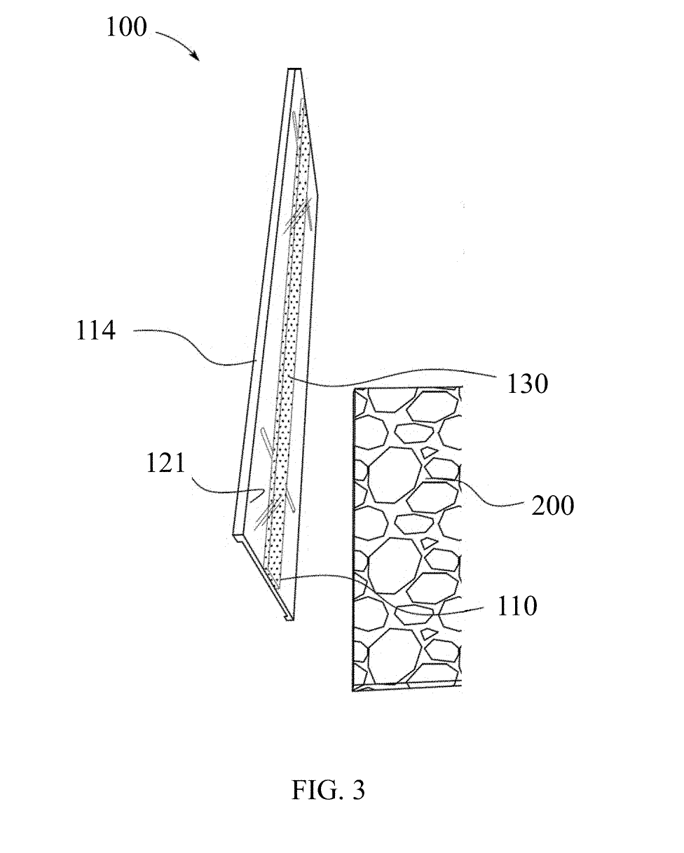

Exemplary FIG. 3 may show an adjustable strip cutting ruler;

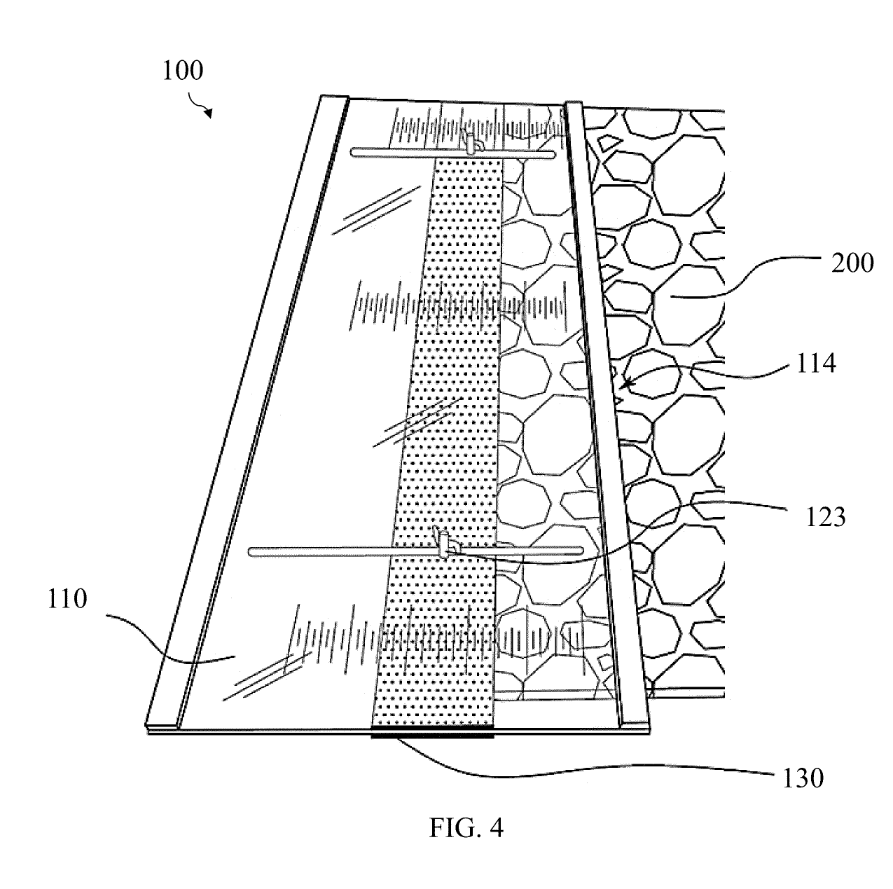

Exemplary FIG. 4 may show an adjustable strip cutting ruler;

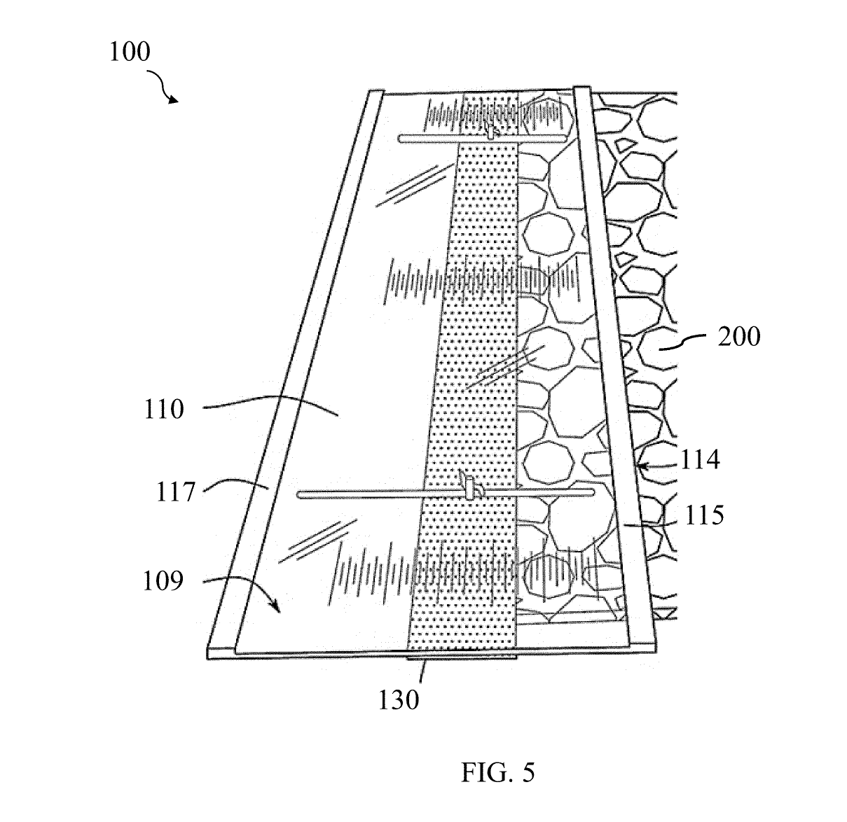

Exemplary FIG. 5 may show an adjustable strip cutting ruler; and

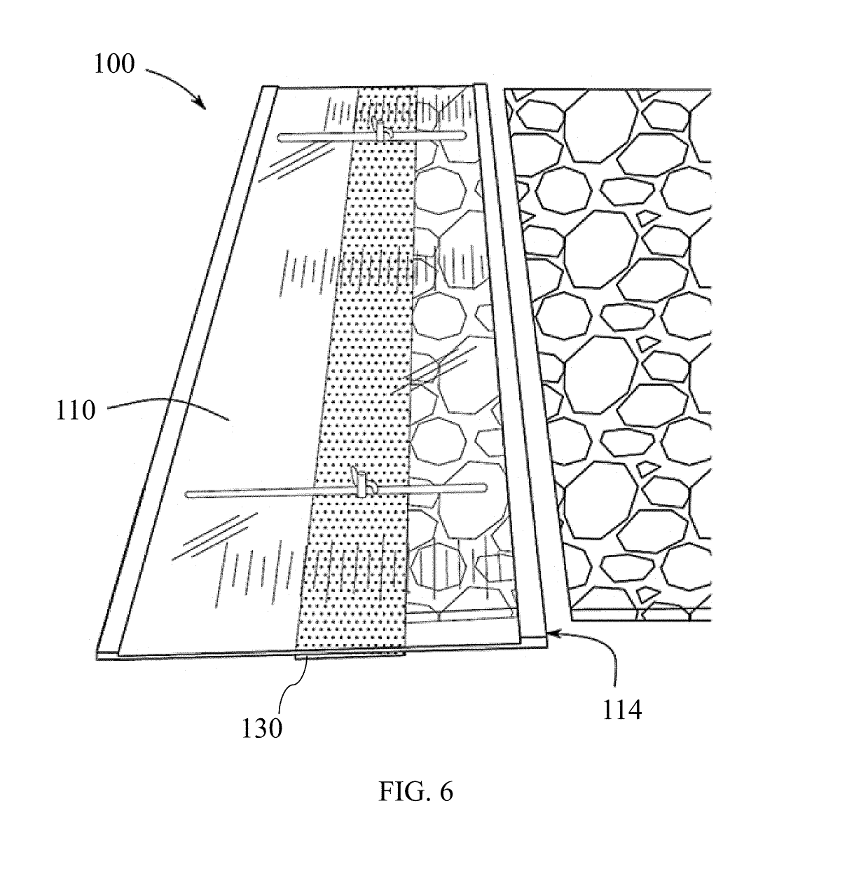

Exemplary FIG. 6 may show an adjustable strip cutting ruler.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to an exemplary embodiment, an adjustable strip cutting ruler may be provided. The adjustable strip cutting ruler may be used to cut materials, such as sheet materials, into strips having uniform, predetermined widths. The adjustable strip cutting ruler may facilitate cutting operations of one or more layers of material simultaneously. The adjustable strip cutting ruler may include a ruler body having a top surface and a bottom surface. At least one track may extend along a length of the ruler body for slidably mounting a glide. The glide may be able to freely traverse the ruler body along the bottom surface. The ruler body may further include measurement markings to align the glide at a desired width for cutting strips of material.

Now referring to FIGS. 1-6 generally, an adjustable strip cutting ruler 100 may be shown. Ruler 100 may include a ruler body 110. Ruler body 110 may be substantially rectangular. Ruler body 110 may have length-wise edges 112, 114 and ruler body 110 may have width-wise edges 116, 118. In an exemplary embodiment, ruler body 110 may be sized such that the length of ruler body 110 is greater than the cross-sheet length of a desired sheet material, which is to be cut into strips. Ruler body 110 may further be sized, such that the width of ruler body 110 is greater than the desired width of a strip to be cut. In one exemplary embodiment, ruler body 110 may be sized to cut strips up to approximately six inches in width, as would be understood by a person having ordinary skill in the art. Ruler body 110 may further have at least one track 120 disposed there-through. In an exemplary embodiment, ruler body 110 may include two tracks 120, 122 disposed there-through. Tracks 120, 122 may run substantially parallel to width-wise edges 116, 118. Track 120 may be proximate width-wise edge 116 and track 122 may be proximate width-wise edge 118. Body 110 may further include a top surface 109 and a bottom surface 111. Body 110 may optionally have finger guards 115, 117 disposed on the top surface 109 proximate edges 112, 114. Finger guards 115, 117 may be a raised lip or strip running along edges 112, 114 and may protect fingers from a passing cutter, such as a rotary blade cutter. Finger guards 115, 117 may be flush with edges 112, 114 and may be shaped and sized to allow a desired cutter to run along edges 112, 114, while cutting a material under ruler 100. In some exemplary embodiments, finger guards 115, 117 may be approximately ¼ inch wide. Finger guards 115, 117 may optionally be formed integral to body 110 or may be affixed to the top surface of ruler body 110.

In an exemplary embodiment, length-wise edge 114 may be used as a cutting guide. A glide 130 may be slidably secured to a bottom surface 111 of ruler body 110. Glide 130 may be secured to ruler body 110 by fasteners 123 disposed through tracks 120, 122. Fasteners 123 may optionally include corresponding screws, bolts, nuts, pegs, rivets or other fasteners that would allow glide 130 to operate as described herein. In an exemplary embodiment, fasteners 123 may loosen to allow glide 130 to slide along tracks 120, 122. Fasteners 123 may also tighten to secure glide 130 at a desired point along tracks 120, 122. Ruler body 110 may include at least one set of ruler markings running from edge 114 to edge 112. Ruler markings may be read on top surface 109. Ruler markings may be in any desired increments or measurement units, as would be understood by a person having ordinary skill in the art. Exemplary units may include millimeters, centimeters, or inches. In an exemplary embodiment, there may be three ruler marking sets 124. Ruler marking sets 124 may be spaced along the length of body 110. Glide 130 may be secured at a desired point along ruler marking sets 124, indicating the width of a desired strip of material to be cut along edge 114. The multiple ruler marking sets 124 may be used to ensure that glide 130 is aligned evenly at the desired measurement.

In some further exemplary embodiments, bottom surface 111 may include grip material 121 disposed proximate edge 114. Grip material 121 may be applied to the surface of ruler 100 to securely retain sheet material or fabric in a desired orientation for cutting.

In an exemplary embodiment, ruler body 110 may optionally be substantially transparent. Glide 130 may be colored such that it can be seen through ruler body 110. This may allow a user to align glide 130 with desired measurement markings. In one exemplary embodiment, ruler body 110 may be a transparent fluorescent green and glide 130 may be transparent fluorescent orange.

Still referring to FIGS. 1-6 generally, an exemplary embodiment of a method for cutting a strip of material may be provided. The material may be cut by a cutting device utilizing an adjustable strip cutting ruler as an assistive device. In some exemplary embodiments, the cutting device may be a knife, rotary blade cutting tool, or other comparable cutting device as would be understood by a person having ordinary skill in the art. The versatility of the adjustable strip cutting ruler 100 may allow the placement and cutting of multiple layers of material at a given time. The adjustable strip cutting ruler 100 may be placed on top of at least one sheet of material 200 with bottom surface 111 proximate the at least one sheet of material 200 to be cut. Grip material or adhesive strips on the underside of the ruler body 110 may assist in retaining the fabric or sheet material in a desired location. Edges 116 and 118 may be positioned substantially perpendicular to edges 112 and 114. Edge 116 or 118 may be aligned along a factory-cut side edge 202 of the sheet material 200, as shown in FIG. 2. Ruler 100 may be positioned such that a working end 204 of sheet material 200 extends beyond edge 114. A user may cut sheet material 200 along edge 114 of ruler 100 to create a straight working end 204, perpendicular to factory-cut side edge 202.

Glide 130 may then be secured in a desired position along tracks 120, 122, creating a distance from glide 130 to cutting edge 114 that matches a desired width for the strip of material to be cut. Ruler 100 may be placed on sheet material 200, such that glide 130 abuts the working end 204 and cutting edge 114 rests on top of material 200. A user may optionally apply a downward pressure on ruler 100, securing the desired orientation of ruler 100 and material 200. Cutting device (not shown) may then be used to cut material 200 along guide edge 114. This may create a strip of material 200 having a desired width.

In an exemplary embodiment, if glide 130 is two inches in width, and ruler 100 is capable of cutting strips up to six inches in width, ruler body 110 may be eight inches in width. Tracks 120, 122 may run from one inch in of each length-wise edge and fasteners 123 may pass through glide 130 at a midpoint of its width, allowing glide 130 to travel from one lengthwise edge to the other, as would be understood by a person having ordinary skill in the art. Measurement markings may run from edge 114 to two inches from edge 112, allowing an abutting edge of glide 130 to travel the full six inches of measurement. A variety of sizes, however, may be used to correspond to a desired use and sheet material.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An adjustable strip cutting ruler comprising:
a ruler body having a top surface and a bottom surface;
at least one track extending through the ruler body along a lateral axis thereof;
a glide coupled to the bottom surface of the ruler body and configured to slide along a length of the at least one track;
at least one fastener pivotally attached to the glide for mounting the glide to the at least one track; and
at least one set of ruler markings spaced along the lateral axis of the ruler body.

2. The adjustable strip cutting ruler of claim 1, further comprising:
at least one finger guard disposed on the top surface of the ruler body.

3. The adjustable strip cutting ruler of claim 2, wherein the at least one finger guard extends a length of the ruler body proximate a longitudinal edge thereof

4. The adjustable strip cutting ruler of claim 2, wherein the at least one finger guard is one quarter inch in width.

5. The adjustable strip cutting ruler of claim 1, further comprising:
grip material disposed on the bottom surface of ruler body.

6. The adjustable strip cutting ruler of claim 1, wherein the at least one fastener is rotatable in a tightening direction to secure the glide at a desired position along the at least one track and in an opposite loosening direction to allow the glide to slide along the at least one track.

7. The adjustable strip cutting ruler of claim 1, wherein the ruler body is composed of a transparent material and the glide is visible through the ruler body.

8. The adjustable strip cutting ruler of claim 7, wherein the ruler body is a transparent fluorescent green and the glide is a transparent fluorescent orange.

9. The adjustable strip cutting ruler of claim 1, wherein there are two tracks extending through the ruler body, the two tracks running substantially parallel to lateral side edges of the ruler body.

10. The adjustable strip cutting ruler of claim 1, wherein there are three sets of ruler markings disposed on the top surface of the ruler body.

11. The adjustable strip cutting ruler of claim 1, wherein the ruler body is sized to cut a material strip up to six inches in width.

12. The adjustable strip cutting ruler of claim 1, wherein the ruler body is rectangular.

13. The adjustable strip cutting ruler of claim 1, wherein the at least one fastener attaches to the glide at a midpoint along a lateral axis thereof.

14. The adjustable strip cutting ruler of claim 1, wherein the at least one fastener comprises a bolt and a nut.

15. A method of cutting a strip of material comprising:
providing at least one sheet of material to be cut;
providing an adjustable strip cutting ruler, the adjustable strip cutting ruler comprising:
a ruler body having a top surface and a bottom surface;
at least one track extending through the ruler body along a, lateral axis thereof;
a glide coupled to the bottom surface of the ruler body and configured to slide along a length of the at least one track;
at least one fastener pivotally attached to the glide for mounting the glide to the at least one track; and
at least one set of ruler markings spaced along the lateral axis of the ruler body;
securing the glide at a desired position along the length of the at least one track, the desired position corresponding to a desired width for the strip of material to be cut;
positioning the adjustable strip cutting ruler on top of the at least one sheet of material with an edge of the glide abutting an edge of the at least one sheet of material; and
cutting the at least one sheet of material along a longitudinal side of the ruler body.

16. The method of claim 14 further comprising:
loosening the at least one fastener to allow the glide to slide along the at least one track.

17. The method of claim 14 further comprising:
tightening the at least one fastener to secure the glide at the desired position along the length of the at least one track.

18. The method of claim 14, further comprising:
applying pressure to the adjustable strip cutting ruler to secure a desired orientation prior to cutting the at least one sheet of material.

19. The method of claim 12, further comprising:
aligning longitudinal edges of the ruler body to be substantially perpendicular with lateral edges of the ruler body.

20. The method of claim 12, further comprising:
creating a straight working end of the at least one sheet of material, the working end being perpendicular to a factory-cut side edge of the at least one sheet of material.
